(19) United States
(12) Patent Application Publication
(10) Pub. No.: US 2009/0171052 A1
(43) Pub. Date: Jul. 2, 2009

(54) Polyelectrolyte Monolayers and Multilayers for Optical Signal Transducers

(75) Inventors: Karlheinz Hildenbrand, Krefeld (DE); Stephan Schwers, Koln (DE); Elke Reifenberger, St. Augustin-Hangelar (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions Diagnostics GMBH, Malvern, PA (US)

(21) Appl. No.: 12/097,941

(22) PCT Filed: Dec. 8, 2006
(86) PCT No.: PCT/EP2006/011827

§ 371 Date: Nov. 12, 2008

(30) Foreign Application Priority Data
Dec. 21, 2005 (EP) 05027985.0

(51) Int. Cl. C08F 12/28

(52) U.S. Cl. 526/310

(57) ABSTRACT

Polyelectrolyte monolayers and multilayers for coating optical signal transducers are disclosed.

The invention relates to processes for coating dielectric materials with polyelectrolyte mono- and multilayers and to an optical signal transducer with a coating of these polyelectrolyte layers and to the use thereof.

Dielectric materials are modified with polyelectrolyte mono- or multilayers for bio- and chemofunctionalization, with the aim of being able to immobilize chemical and/or biochemical ((bio)chemical) recognition elements, for example receptors, antibodies, DNA, etc., on their surface. Such coated dielectric materials, for example coated optical waveguides, find use as signal transducers, as used in sensor technology in bio- or chemosensors.

Bio- or chemosensors refer to instruments which can qualitatively or quantitatively detect an analyte with the aid of a signal transducer and a recognition reaction. A recognition reaction is defined quite generally as the specific binding or reaction of an analyte with a recognition element. Examples of recognition reactions are the binding of ligands to complexes, the complexation of ions, the binding of ligands to (biological) receptors, membrane receptors or ion channels, of antigens or haptens to antibodies, of substrates to enzymes, of DNA or RNA to certain proteins, the hybridization of DNA/RNA/PNA or the processing of substrates by enzymes. Analytes may be: ions, proteins, natural or synthetic antigens or haptens, hormones, cytokines, mono- and oligosaccharides, metabolism products, or other biochemical markers which are used in diagnosis, enzyme substrates, DNA, RNA, PNA, potential active ingredients, medicaments, cells, viruses. Examples of recognition elements are: complexing agents for metals/metal ions, cyclodextrins, crown ethers, antibodies, antibody fragments, anticalins¹, enzymes, DNA, RNA, PNA, DNA/RNA-binding proteins, enzymes, receptors, membrane receptors, ion channels, cell adhesion proteins, gangliosides, mono- or oligosaccharides.

These bio- or chemosensors may be used in environmental analysis, the nutrition sector, human and veterinary diagnostics and crop protection in order to determine analytes qualitatively and/or quantitatively. The specificity of the recognition reaction enables even analytes in complex samples, for example atmospheric air, contaminated water or body fluids, to be determined qualitatively or quantitatively only with minor preceding purification, if any.

In addition, bio- or chemosensors may also be used in (bio)chemical research and the search for active compounds in order to investigate the interaction between two different substances (for example between proteins, DNA, RNA, or biologically active substances and proteins, DNA, RNA, etc.).

The recognition reaction may be integrated with the signal transducer to give a bio- or chemosensor by immobilizing the recognition element or the analyte on the surface of the signal transducer. The recognition reaction, i.e. the binding or the reaction of the analyte with the recognition element, results in a change in the optical properties of the medium directly on the surface of the signal transducer (for example changing the optical refractive index, the absorption, the fluorescence, the phosphorescence, the luminescence, etc.), which is converted by the signal transducer to a measurement signal.

Optical waveguides are a class of signal transducers by which the change in the optical properties of a medium can be detected, said medium bordering a waveguide layer, typically a dielectric. When light is transported as a conducted mode in the waveguide layer, the light field does not decay abruptly at the medium/waveguide interface, but rather decays exponentially in the detection medium adjoining the waveguide. This exponentially decaying light field is referred to as an evanescent field. When very thin waveguides are used, whose refractive index differs very greatly from that of the adjacent medium, decays in the evanescent field (intensity decays to the value 1/e) of <200 nm are achieved. When the optical properties of the medium bordering the waveguide change (for example change in the optical refractive index^{2,3}, in the luminescence^{4,5,6}, etc.) within the evanescent field, this may be detected using a suitable measurement setup. It is crucial for the use of waveguides as signal transducers in bio- or chemosensors that the change in the optical properties of the medium is detected only very close to the interface of the waveguide. This is because immobilization of the recognition element or of the analyte at the interface of the waveguide may result in the binding to the recognition element or the reaction of the recognition element being detected in a surface-sensitive manner when this changes the optical properties of the detection medium (liquid, solid, gaseous) at the interface to the waveguide.

When optical waveguides are used as bio- or chemosensors, high requirements are placed on the waveguide to detection medium interface:
Under reaction conditions of the recognition reaction, the waveguide/detection medium interface must be stable.
The recognition elements must be immobilized within the range of the evanescent field of the waveguide.
Under the reaction conditions of the recognition reaction, the immobilization of the recognition element must be stable.
The functionality of the recognition elements must still be present even after the immobilization.
In order that only the specific recognition reaction is detected by the signal transducer, any kind of unspecific binding at the waveguide/detection medium interface must be suppressed.

Recognition elements can be immobilized at the surface of waveguides in a wide variety of ways. This can be done, for example, by physisorption of the recognition elements at the signal transducer surface. Clerc and Lukosz⁷ describe the physisorption of avidin at SiO₂—TiO₂ waveguide surfaces. In a second step, utilizing the high-affinity avidin-biotin binding, biotinylated antibodies can be immobilized on the avidin layers thus applied. One disadvantage of this immobilization method of recognition elements on waveguide surfaces is the instability of the physisorbed avidin layer. A change in the reaction conditions, for example temperature changes, pH changes, addition of detergents, etc., can lead to desorption of the avidin layer and hence also of the antibody.

G. Gao describes, in Surface & Coating Technology (2005) 244-250, an “oxygen plasma” method which enables adsorptive binding of DNA to silica wafers.

However, it is known that activated surfaces obtained by plasma treatment do not possess good long-term stability and are therefore considered to be critical with regard to reproducibility.

The recognition elements, also referred to as capture molecules, can also be bonded covalently to the surface of a waveguide. One possibility for this purpose is that of bifunctional silanes which enter into a covalent bond with the waveguide surface⁸. By means of a second functional group in this silane, the recognition elements, for example proteins or DNA⁹, can be bonded covalently. These bifunctional silanes are very reactive and it is necessary to work under absolutely dry reaction conditions in the course of covalent bonding to the waveguide surface, in order to avoid hydrolysis of the reactive silane. The binding of the recognition elements via these silanes to the waveguide surfaces is stable under acidic, neutral and slightly basic conditions. At pH values above 9, however, hydrolysis of the silane can occur, which can lead to desorption of the recognition elements from the surface. A further disadvantage of this immobilization method lies in the relatively high unspecific adsorption of proteins, for example albumin, onto the waveguide surfaces thus functionalized¹⁰. The unspecific binding to these waveguide surfaces can be reduced by, after the binding of the recognition elements, in a second step, binding blocking agents, for example polyethylene glycols¹¹, to the surface.

Alternatively, the binding of hydrophilic polymers, for example polyacrylamides, dextrans, polyethylene glycols, etc., to waveguide surfaces which have been silanized beforehand is described¹². These polymers have the task of minimizing the unspecific binding of proteins, etc., to the surface. The recognition elements are then bonded covalently to these polymers in a further step. Problems with this surface functionalization are that several steps have to be carried out to immobilize the recognition elements on the surface and the instability of the silane bond on the waveguide surfaces at pH>9.

The recognition elements may also be bound to polymers which, without preceding silanization, are applied directly to the waveguide layers.

Polymers as the interface between waveguide surface and recognition element are the subject matter of the present description.

Taking account of the abovementioned requirements on the waveguide/detection medium interface, the polymer interface, under the reaction conditions, must enable an irreversible bond both to the substrate and to the recognition element, and, owing to the intensity falling by 1/e, it must be very thin.

Polymer monolayers which additionally, after the attachment of the recognition elements arranged pointwise, enable blocking against nonspecific adsorption of disruptive components in a very simple process step would therefore be advantageous.

Since the surfaces of waveguide layers and generally of substrates are different according to the field of use and generally are not known exactly with regard to surface chemistry, the provision of suitable polymers is a great challenge for the production of high-performance bio- or chemosensors.

There has therefore been no lack of attempts to prepare tailored polymers for particular substrate surfaces by synthesis.

With regard to coating of substrates with metal oxide surfaces, such as TiO₂, Nb₂O₅ or Ta₂O₅, ionic polymers, for example, have also been described.

WO 03/020966 describes poly(L-lysine)-g-poly(ethylene glycol) graft copolymers (PLL-g-PEG). In this abbreviation, “g” refers to the grafting ratio, i.e. the quotient of the number of lysine units and the number of polyethylene glycol side chains. It has been found that, with these PLL-g-PEG graft copolymers, good results can be achieved only when the grafting ratio “g” is within the range from 8 to 12 and the PEG side chains are within the molecular weight range from 1500 to 5000 g/mol.

This complex and narrowly defined specialty polymer meets the requirements made with regard to good availability, uniform quality and universal applicability for different substrate surfaces only inadequately.

A further disadvantage of this method is that of the instability of these layers with respect to pH values of less than 3 and greater than 9, and also with respect to high salt concentrations, since the electrostatically bound polymer was desorbed from the surface under these conditions.

WO 02/068481 describes phosphorus-containing polymers for coating dielectric materials and the use therefor in optical signal transducers. These are water-soluble polymers which are prepared, for example, by reacting polyallylamine hydrochloride with formaldehyde and phosphorous acid, by the Mannich Mödritzer reaction.

These polyphosphonamides possess, as well as cationic groups, also anionic groups which are, if anything, counterproductive to attachment of recognition molecules, for example DNA by an electrostatic group. Furthermore,

experience has shown that the abovementioned Mannich Mödritzer reaction is a method which, owing to side reactions, forms not only the desired polyphosphonamides but also other products.

Gene chip products based on polyelectrolyte binding are, in contrast, owing to their simple mode of production, particularly preferred embodiments in the coating of bio- and chemoreceptors.

B. Laguitton describes, in U.S. Pat. No. 6,689,478, the attachment of DNA recognition molecules to polyelectrolyte (PEL) multilayers, the uppermost binding layer being a cationic polymer (cationic PEL). Polyelectrolytes are polymers which bear ionic or ionizable groups in their repeat unit. Examples of cationic polyelectrolytes are polyamines such as polyethyleneimine (PEI), or polyammonium compounds such as polyallylamine hydrochloride or polydiallyldimethylammonium chloride (P DADMAC). Examples of anionic polymers are the

salts of polyacrylic acids (PAAs), polystyrenesulfonic acids or dextransulfonic acid. Polyelectrolyte multilayers consist of an alternating structure of oppositely charged polyelectrolytes, as described, for example, in “Multilayer Thin Films” G. Decher, Wiley-VCH 2003. While the binding of nucleic acids to PEL multilayers likewise forms part of the prior art (B. Sukhoukov, “Multilayer Films Containing Immobilized Nucleic Acids” Biosensors & Bioelectronics, vol. 11, No. 9, 913-922, 1966), the challenge, as described in U.S. Pat. No. 6,689,478, is to bind the first polymer layer, a cationic polymer, to the substrate made of glass. This challenge is met by treating the glass carriers first in a complex way with hydrogen peroxide and then with sulfuric acid, which anionically modifies the glass surface. B. Laguitton argues against this in U.S. Pat. No. 6,689,478, in that polymer monolayers cannot achieve the requirements with regard to reliable substrate coating.

It has now been found that, surprisingly, polymer modification of substrate surfaces in polymer monolayers is nevertheless possible when the abovementioned polyelectrolyte polymers which are available readily and in high quality have a particularly high molecular weight.

Proceeding from a waveguide with a Ta₂O₅ surface of high refractive index, it has first been found, in a screening process with various cationic and anionic polyelectrolytes, that this surface exhibited no affinity whatsoever for anionic polyelectrolytes.

Within the group of the cationic polyelectrolytes, i.e. polymers which bear ammonium structures in their repeat unit, it has been found, for example, that polyvinylamines with the molecular weight (MW) of 50 000 g/mol, did not exhibit sufficient affinity for the Ta₂O₅ surface, while polyvinylamines with the MW of 340 000 g/mol satisfied all prerequisites.

Polyvinylamines are polymers which are prepared by acidic or alkaline hydrolysis of poly(N-vinylformamides), as described in J. Appl. Pol. Sci. Vol. 86, 3412-3419 (2002). The corresponding products are produced in various molecular weights by BASF AG under the trade name “Lupamin”. These products are used on a large scale, for example, as paper chemicals, in the personal care sector, as super-absorbents or dispersants. The Lupamin commercial products still contain the salts formed from the hydrolysis. For the application sector described, the modification of waveguide surfaces, both the salt-containing and the desalinified form can be used. The desalinification can be effected, for example, by ultrafiltration.

The findings were similar with linear polyethyleneimines (lPEIs). While lPEIs with MW of 25 000 g/mol (from Polyscience Inc.) did not meet the requirements, it was again possible to meet all requirements with the very high molecular weight lPEIs of 500 000 g/mol. Polyamines with uncharged nitrogen in their repeat unit, in aqueous solution, are likewise included among the cationic polyelectrolytes, since they are at least partly protonated under these conditions.

Useful further cationic polyelectrolytes of high molecular weight include poly(diallyldimethylammonium chloride), which is readily available as an aqueous solution in the molecular weight range of MW 400 000-500 000 g/mol. In contrast to the aforementioned cationic polyelectrolytes, this comprises quaternary ammonium groups, i.e. the charge state is independent of the pH.

Using the example of Lupamin 9095 (polyvinylamine PVAm 340 000 g/mol), the process according to the invention for producing a planar waveguide (PWG) with DNA as the recognition molecule (capture DNA) will be described below.

1. Loading of the Substrate with Lupamin 9095

The substrate (PWG made of quartz glass with Ta₂O₅ surface) is immersed into a highly dilute Lupamin 9095 solution (0.005% in water) for 30 min and then in water for 30 min, and dried.

### 2. Application of the Capture DNA Spots

With the aid of a micropipette, a dye-labeled DNA solution (approx. 10⁻¹⁰ M) is pipetted onto the polymer-coated Ta₂O₅ side and incubated (left to stand) at RT for 20 min.

### 3. Blocking of the Unspotted Surface

The PWG provided with the capture DNA spot is immersed into an aqueous dextran sulfate (DexS) solution (MW: 500 000 g/mol, 0.05% in water) for 30 min and washed briefly with water.

The PWG thus provided with capture DNA spots can be used directly for hybridization tests.

The method described here is a process whose simplicity and reproducibility can barely be surpassed.

In addition to the good availability of the polymers, in particular, the number and the simplicity of the individual process steps should be mentioned.

For example, Laguitton in U.S. Pat. No. 6,689,478, where capture DNA is bound to polyelectrolyte multilayers (alternating sequence of cationic and anionic polyelectrolyte monolayers), includes the following individual steps, some of them quite complex:

Functionalization of the substrate surface with H₂O₂ and sulfuric acid, multiple application of various polyelectrolytes, pipette application of the capture DNA, washing off the capture DNA excess, blocking the unspotted surface with a bifunctional reagent and washing off the reagent excess.

In this connection, reference shall be made in particular to step 3 (blocking) of the process according to the invention.

When the PWG with the capture DNA spot(s) is immersed into the dextran sulfate solution, the capture DNA excess is simultaneously washed off, and the polyelectrolyte binding of the dextran sulfate to the unspotted Lupamin surface achieves blocking with regard to unspecific adsorption of DNA. Dextran sulfate as a blocking medium in DNA chips is also advantageous in that dextran sulfate is frequently likewise used as an assistant in the appropriate hybridization buffer in the subsequent recognition reaction (hybridization).

Even though the polymers mentioned so far, Lupamin 9095 and dextran sulfate, are used with preference, it is possible in principle to use alternative polyelectrolyte combinations.

With regard to cationic polyelectrolytes which bind to the substrate surface in high affinity and enable an ionic or covalent attachment of the capture DNA, for example, all known cationic polyelectrolytes are useful, provided that they have a very high molecular weight, preferably higher than 100 000 and more preferably higher than 250 000 g/mol. Examples are polyallylamine, polydimethyldiallylammonium chloride, polyvinylpyridine, cationically modified polyacrylates and polyethyleneimine (PEI), which may be present either in branched or linear form according to the mode of preparation. Linear, very high molecular weight PEI can be prepared easily from the readily available poly(2-ethyl-2-oxazoline) (MW: 500 000 g/mol) by acidic hydrolysis.

The cationic polyelectrolytes mentioned may be used either in the form of the hydrochloride or in their aminic form. This is because the aminic form is partly protonated in aqueous solution and therefore likewise has cationic charge properties in this form.

With regard to anionic polyelectrolytes which are used for anionic blockage against nonspecific DNA by virtue of interaction with the cationic surface, useful anionic polyelectrolytes apart from dextran sulfate are all known anionic polyelectrolytes, for example the sodium salts of polystyrenesulfonic acid, polyacrylic acid or polyacrylic acid copolymers or polymaleic acid and copolymers thereof.

While, as mentioned above, a very high molecular weight is required for the abovementioned cationic polyelectrolytes for the process according to the invention, the anionic polyelectrolytes can also be used in their low molecular weight form.

For example, with dextran sulfate both with MW 5000 and 500 000 g/mol, outstanding blocking properties against nonspecific DNA adsorption have been achieved.

Even though the test elements based on physisorption (polyelectrolyte interaction) are preferred with regard to DNA chips in the process according to the invention, the substrates modified with cationic polyelectrolytes in their aminic form can also be modified by means of covalent binding mechanisms. For instance, it is known that biomolecules can be coupled onto aminic surfaces via bifunctional reagents, such as glutaraldehyde or bis-N-hydroxysuccinimides, for example disuccinimidyl suberate (DSS) or sulfo-DSS.

In analogous manner, the blocking step can also proceed via covalent binding mechanisms. For example, with regard to nonspecific protein adsorption, polyethylene glycols, amine-modified polyethylene glycols or hyperbranched polyglycerols (from Hyperpolymers GmbH) can be coupled on via bifunctional reagents. Polyethylene glycols can, for example, also be coupled on via isocyanate-functionalized polyethylene glycols, for example polyethylene glycol monomethyl ether or succinimidyl ester-derivatized polyethylene glycols (Shearwater Polymers).

The particularly preferred process described, based on high molecular weight cationic polyelectrolytes as the polymer interface and anionic polyelectrolytes as the blocking layer against unspecific DNA adsorption, is based on substrates with metal oxide, preferably Ta₂O₅, surfaces.

In the case of other substrate surfaces which, for example, have a partial positive charge, these conditions may correspondingly be reversed, such that anionic high molecular weight polyelectrolytes may serve as the polymer interface.

The high molecular weight cationic polyelectrolytes are suitable preferentially for the anchoring of the polymer onto waveguides formed from materials such as TiO₂, Ta₂O₅, ZrO₂, HfO₂, Al₂O₃, SiO₂ (Si(Ti) O₂),

In₂O₃/SnO₂ (ITO), aluminum silicates, Nb₂O₅, vanadium oxides, or mixtures of these materials. The waveguide materials may, though, also be oxides or hydroxides of the following elements which may form oxides or hydroxides: Sc, Y, Ti, Zr, Hf, V, Nb, Ta, Cr, Mo, W, Mn, Tc, Re, Fe, Ru, Os, Co, Rh, Ir, Ni, PD, Pt, Cu, Ag, Au, Zn, Cd, Hg, B, Al, Ga, In, Tl, Ge, Sn, Pb, As, Sb, Bi, lanthanides, actinides and mixtures thereof, and likewise mixtures of group IIa (Be, Mg, Ca, Sr, Ba, Ra) and VIb (Se, Te, Po).

The polymer is applied to the waveguide surfaces from organic or preferably aqueous solution. This can be done by incubation in the solution, such as immersion, spraying, spotting, spin-coating or other customary processes. Typically solutions between 0.1 and 0.0001% by weight, especially between 0.05 and 0.001% by weight, are used and the waveguide surfaces are coated at temperatures between 0 and 200° C., especially between 20 and 30° C. The incubation time of the waveguide materials with the polymer solutions may be between 10 s and 48 h, typically between 10 min and 24 h. After the incubation, the waveguides are rinsed with organic solvents or aqueous solutions and, if appropriate, derivatized further.

Polyelectrolytes for bio- and chemofunctionalization chemisorb from organic or aqueous solution onto waveguide surfaces. Owing to the specific polyelectrolyte binding to waveguide materials, they form a stable layer on the waveguide. The binding is stable over a wide pH range (pH=1 to pH=14), temperature range (0° C. to 100° C.), and also toward high salt concentrations (1M). Nor does the presence of detergents in the reaction solution lead to desorption of the polymer from the waveguide surface. Since, after polyelectrolyte coverage of the substrate surface with a monomolecular layer, further adsorption of polymers of the same charge is prevented, it is possible to apply only a monolayer of polymer on the surface

entirely in the manner of a chemisorption. This makes it possible to ensure that recognition elements are immobilized within the evanescent light field and hence in the sensitive detection range of the signal transducer.

The waveguide chips coated in the manner described can be used for any kind of qualitative, semiquantitative or quantitative analytical assays.

Recognition elements may be immobilized directly or with the aid of a crosslinker, covalently, coordinatively or via another bond, onto the functional groups of the polymer and hence onto the surface of the bio- or chemosensor. The direct coupling of the recognition elements can be effected before the coating of the waveguides with the polymer or thereafter. The recognition elements can be bonded covalently to the functional groups of the polymer via their own functional groups such as carboxylic acid, carboxylic

ester, carbonyl chloride, carboxylic anhydride, carboxylic acid nitrophenyl ester, carboxylic acid N-hydroxysuccinimide, carboxylic acid imidazolide, carboxylic acid pentafluorophenyl ester, hydroxyl, toluenesulfonyl, trifluoromethylsulfonyl, epoxy, aldehyde, ketone, β-dicarbonyl, isocyanate, thioisocyanate, nitrile, amine, aziridine, hydrazine, hydrazide, nitro, thiol, disulfide, thiosulfite, halogen, iodoacetamide, bromoacetamide, chloroacetamide, boric ester, maleimide, α,β-unsaturated carbonyls, phosphate, phosphonate, hydroxymethylamide, alkoxymethylamide, benzophenone, azide, triazene, acylphosphine. The combination of which functional group of the recognition element reacts with which functional group of the polymer arises from the possible reactions which are known to the chemist between the functional groups.

Proteins as recognition elements can, for example, be immobilized on the polymer via their amino acid side chains. Specific amino acids, for example lysine, cysteine, serine, tyrosine, histidine, glutamate, aspartate, which are localized on the surface of a protein, have functional groups in their side chains which can enter into a covalent bond with the functional groups of the polymer. Functional groups may also be obtained in the recognition elements by derivatization (phosphorylation of tyrosines), oxidation (e.g. oxidation of diol units of glycosylated proteins to aldehyde groups), reduction (for example of disulfide bridges to thiols) or coupling of a crosslinker.

In addition to the covalent immobilization of the recognition elements on the polymer, the recognition elements can also be bound coordinatively to the polymer. Molecular biology methods can be used to prepare, for example, proteins such as enzymes, antibody fragments and receptors with specific affinity sequences, for example the 6×histidine tag¹³. These affinity sequences have a high

affinity and specificity for metal ion complexes, for example nickel nitrilotriacetic acid or copper iminodiacetic acid, which can be introduced into the polymer as functional group F.

Alternatively, it is also possible to utilize biochemical recognition reactions in order to immobilize recognition elements on the polymer. The very specific and high-affinity binding of biotin to streptavidin¹⁴ can be used to immobilize recognition elements on the polymer. To this end, the streptavidin first has to be immobilized. The recognition element is then functionalized with biotin and can be bonded indirectly to the polymer via the streptavidin-biotin interaction. Alternatively, the recognition element can be provided by means of molecular biology or chemistry with a short amino acid sequence, the so-called StrepTag²⁴, which likewise has a high specificity and affinity for streptavidin.

The inventive signal transducers, characterized in that the recognition elements are bound on polyelectrolyte monolayers, are the preferred subject matter of the present application. In spite of this, it may sometimes be advantageous when the recognition elements are bound on polyelectrolyte multilayers. A multilayer structure does induce a large distance of the recognition element from the waveguide surface—and hence a reduced sensitivity—but, on the other hand, defect sites in the multilayer process can be balanced out by so-called “bridge effects”.

What is essential for the inventive substrate coating is, however, that the polyelectrolyte used for the first substrate coating has a very high molecular weight, preferably greater than 100 000 and more preferably greater than 250 000 g/mol. For the subsequent layers, it is also possible to use polyelectrolytes with lower molecular weight.

One embodiment of the inventive immobilization surfaces is that of use on optically transparent carriers, which are characterized in that they comprise continuous or individual wave-guiding regions (optical waveguides). The optical waveguide is more preferably an optical layer waveguide with a first, essentially optically transparent layer (a) facing the immobilization surface on a second, essentially transparent layer (b) with lower refractive index than layer (a). It is also preferred that said optical waveguide is essentially planar.

The characterizing feature of such an embodiment of an inventive immobilization surface on an optical layer waveguide as a carrier is that, for absorption of excitation wave light into the optical transparent layer (a), this layer is an optical contact to one or more optical absorption elements from the group formed by prism couplers, evanescent fields, end face couplers with focused lenses arranged in front of one end side of the waveguide layer, and grating couplers.

It is preferred that excitation light is absorbed into the optically transparent layer (a) with the aid of one or more grating structures (c) which are formed in the optically transparent layer (a).

The invention provides a surface for immobilization of one or more first nucleic acids as recognition elements to produce a recognition surface for detection of one or more second nucleic acids in one or more samples contacted with the recognition surface, the first nucleic acids being applied on a cationic high molecular weight polyelectrolyte layer as a surface for immobilization.

Particular preference is given to those embodiments of an inventive immobilization surface in which the nucleic acids immobilized thereon are arranged as recognition elements in discrete (spatially separate) measurement areas. Up to 2 000 000 measurement areas may be arranged in a two-dimensional arrangement, and an individual measurement area may occupy an area from 10⁻⁵ mm² to 10 mm². It is preferred that the measurement areas are arranged in a density of more than 100 and preferably more than 1000 measurement areas per square centimeter.

The discrete (spatially separate) measurement areas on said immobilization surface can be obtained by spatially selective application of nucleic acids as recognition elements, preferably using one or more processes from the group of processes formed by inkjet spotting, mechanical spotting by means of a pen or capillary, microcontact spotting, fluid contacting of the measurement area with the biological or biochemical or synthetic recognition elements by supplying them in parallel or crossed microchannels, under the action of pressure differences or electrical or electromagnetic potentials, and photochemical or photolithographic immobilization processes.

The invention further provides a process for simultaneous or sequential, qualitative and/or quantitative detection of one or more second nucleic acids in one or more samples, characterized in that said samples and if appropriate further reagents are contacted with one of the inventive immobilization surfaces according to one of the embodiments mentioned, on which one or more nucleic acids are bound as recognition elements for specific binding/hybridization with second nucleic acids, and the change in optical or electrical signals resulting from the binding/hybridization of this second nucleic acid and/or further detection substances used for analyte detection is measured.

It is preferred that the detection of one or more second nucleic acids is based on the determination of the change in one or more luminescences. For luminescence generation, various optical excitation configurations are possible. One possibility is that excitation light for excitation of one or more luminescences is introduced from one or more light sources in an incident light excitation arrangement.

Another possible configuration is characterized in that excitation light for excitation of one or more luminescences is introduced from one or more light sources in a transmission light excitation arrangement.

Preference is given to an embodiment of the inventive immobilization surfaces and/or processes, which is characterized in that the surface is arranged on an optical waveguide, in that the one or more samples with second nucleic acids to be detected therein and if appropriate further detection reagents are contacted with the bound first nucleic acids as recognition elements, sequentially or after mixing with said detection reagents, and in that the excitation wave light from one or more light sources is absorbed into the optical waveguide with the aid of one or more optical coupling elements from the group formed by prism couplers, evanescent fields, end face couplers with focused lenses arranged in front of one end side of the waveguide layer, and grating couplers.

It is preferred that the light wave running in the waveguide generates luminescence from molecules capable of luminescence, and that this luminescence is detected by one or more detectors. From the intensity of the luminescence signal, the concentration of one or more nucleic acids for detection can be determined.

The luminescence label may be coupled to the second nucleic acid for detection itself, or be bound in a competitive experiment to molecules with known concentration and sequence, as a competitor, and be added thus to the sample. The luminescence label may, though, also be introduced into the analysis mixture by means of a third binding partner.

It is preferred that the luminescence is generated by using luminescent dyes or luminescent nanoparticles as luminescent labels, which are excited and emit at a wavelength between 300 nm and 1100 nm.

The process according to the invention is characterized in that the samples for study are aqueous solutions,

especially buffer solutions or naturally occurring body fluids, such as blood, serum, plasma, urine or tissue fluids. The samples for study may also be prepared from biological tissue parts or cells.

The invention further provides for the use of the inventive immobilization surfaces and/or processes in qualitative and quantitative DNA and RNA analysis, for example the determination of genomic differences such as single nucleotide polymorphisms (SNPs) or DNA amplifications or DNA deletions or DNA methylation or for detection and quantification of mRNA (expression profiling).

In the examples which follow, waveguides with polymeric monolayers (polyvinylamine hydrochloride) and with three-layer structure (polyvinylamine hydrochloride/dextran sulfate/polyvinylamine

hydrochloride) as immobilization surfaces are described, as is their use in the nucleic acid analysis.

### EXAMPLES

### Example 1

### Modification of a Planar Waveguide with a Monolayer of Polyvinylamine Hydrochloride, Subsequent Doping with Capture DNA Spots and Blocking with Dextran Sulfate

A planar waveguide (Unaxis Balzers, Liechtenstein) of dimensions 2×1 cm, consisting of AF 45 glass with a wave-guiding, optically transparent, high-refractive index Ta₂O₅ layer (refractive index of 2.10 at 633 nm, layer thickness 185 nm) and grating lines running parallel to the width (period 318 nm with grating depth 32+/−3 nm) was
immersed into a 0.005% solution of Lupamin 9095 (from BASF) in water for 30 min.
The Lupamin-modified waveguide was washed in pure water for 30 min.
Excess water residues were dried with a dry N₂ stream.
With the aid of a micropipette, 5 μl of a fluorescence-labeled DNA sequence (Cy5-50 mer: 5′-Cy5-CAA CAG TGC AAC CTT GGA AGC AGA TGT AGA TGT TGT TGT GTC ACC TCC AT 3′, from BioTeZ Berlin) were pipetted onto the high-refractive index, Lupamin-coated surface. In the same way, analogous capture oligo spots were applied to two other sites.
After an incubation time of 30 min at RT, the spotted waveguide was immersed into an aqueous dextran sulfate solution (MW: 500 000 g/mol, from Fluka) for 30 min and washed briefly with water.

The function test was effected by introducing a laser light beam of wavelength 635 nm. At the points at which the capture DNA spots have been pipetted on, brightly glowing points are observed, caused by the emission of the Cy5 fluorescent dye (from Amersham).

For comparison, the abovementioned Cy5 50 mer capture solution was pipetted onto a site which had been blocked against DNA adsorption with dextran sulfate and washed with water. In the subsequent optical function test, no color signal was found at the corresponding sites.

### Example 2

### Modification of a Planar Waveguide with a Polyelectrolyte Triple Layer Composed of Polyvinylamine Hydrochloride/Dextran Sulfate/Polyvinylamine Hydrochloride, Subsequent Doping with Capture DNA Spots and Blocking with Dextran Sulfate

A planar waveguide (Unaxis Balzers, Liechtenstein) of dimensions 2×1 cm, consisting of AF 45 glass with a wave-guiding, optically transparent, high-refractive index Ta₂O₅ layer (refractive index of 2.15 at 633 nm, layer thickness 185 nm) and grating lines running parallel to the width (period 318 nm with grating depth 32+/−3 nm) was
1. immersed into a 0.005% solution of Lupamin 9095 (from BASF) in water for 30 min.
2. The Lupamin-modified waveguide was washed in pure water for 30 min.
3. The waveguide with the Lupamin monolayer was immersed into a 0.05% aqueous dextran sulfate solution for 30 min.
4. This was followed by washing in pure water for 30 min.
5. Repetition of step 1.
6. The waveguide with the polyelectrolyte triple layer was washed in water for 30 min.
7. Excess water residues were dried with a dry N₂ stream.
8. With the aid of a micropipette, 5 μl of a fluorescence-labeled DNA sequence (Cy5-50 mer:
   5′-Cy5-CAA CAG TGC AAC CTT GGA AGC AGA TGT AGA TGT TGT TGT GTC ACC TCC AT 3′, from BioTeZ Berlin) were pipetted onto the high-refractive index, Lupamin-coated surface. In the same way, analogous capture oligo spots were applied to two other sites.
9. After an incubation time of 30 min at RT, the spotted waveguide was immersed into an aqueous dextran sulfate solution (MW: 500 000 g/mol, from Fluka) for 30 min and washed briefly with water.

The function test was effected by introducing a laser light beam of wavelength 635 nm. At the points at which the capture DNA spots have been pipetted on, brightly glowing points are observed, caused

by the emission of the Cy5 fluorescent dye (from Amersham).

For comparison, the abovementioned Cy5 50 mer capture solution was pipetted onto a site which had been blocked against DNA adsorption with dextran sulfate and washed with water. In the subsequent optical functional test, no color signal was found at the corresponding sites.

### Example 3

### Hybridization of Bacterial cDNA on Lupamin-Coated Planar Waveguide Chips

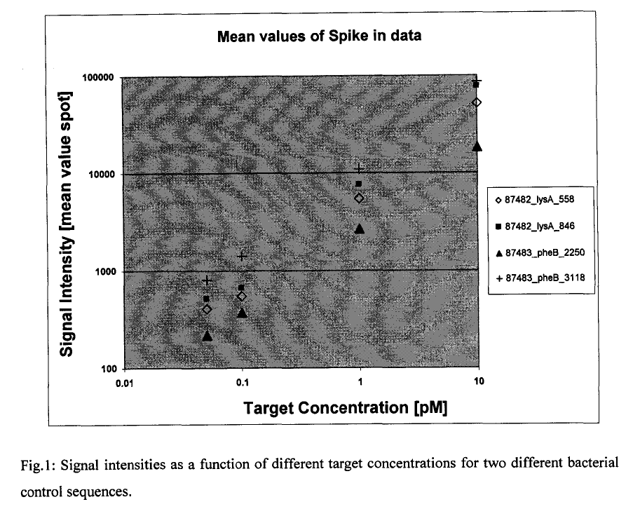

A planar waveguide chip (SensiChip, Zeptosens, Bayer Schweiz AG, Witterswil, Switzerland) of 14 mm×57 mm, consisting of AF 45 glass with a wave-guiding, optically transparent, high-refractive index Ta₂O₅ layer (refractive index of 2.12 at 535 nm, layer thickness 145 nm) and grating lines running parallel to the width (period 318 nm with grating depth 13+/−2 nm), was
immersed into a 0.01% solution of Lupamin 9095 (from BASF) in water for 60 min
then the chips were washed in Millipore water for 30 min and placed into fresh Millipore water for a further 4 hours.
Excess water residues were removed with a dry N₂ stream.
The chips were positioned in a contact spotter and spotted with different oligonucleotide solutions in a concentration of 10⁻⁵ M. The oligonucleotides were synthesized by Operon (Cologne, Germany) and had a length of 70 bases. Four of the
oligonucleotides had a sequence which had bacterial control cDNA complementary to that used in the later hybridization (B. subtilis sequences, ATCC 87482 and 87483; reference sequences X17013 and M24537, The American Type Culture Collection, www.atcc.org)
After an incubation time of 60 min at RT, the spotted waveguide was immersed into an aqueous blocking solution (5% dextran sulfate (MW: 500 000 g/mol), 1% Tween, 10 mM Tris, 30% formamide, pH 8.5) for 5 min and then washed with water for 1 min.
Excess water residues were removed with a dry N₂ stream.
The spotted and blocked chips were placed into the hybridization chambers of the SensiChip system from Zeptosens (Bayer Schweiz AG, Witterswil, Switzerland) according to the system distributor's instructions. According to system instructions, the chips were incubated first in SB buffer and then in PHB buffer. The hybridization mixture which comprised the Cy5-labeled cDNA was likewise made up according to the instructions of the SensiChip system. The cDNA had been synthesized beforehand in a labeling reaction with the aid of the label-star kit from Qiagen Hilden, Germany, with the fluorescent dye Cy5 (Amersham, Arlington Heights, USA) from the bacterial mRNA. Immediately before introduction into the hybridization chambers, the hybridization mixture was heated at 95° for 5 min. The cDNA was used in concentrations of from 5×10⁻¹⁴ M to 10⁻¹² M based on the starting amount of RNA. The hybridization volume was 40 μl. After incubation at 42° C. overnight, the chips were washed with the system wash buffers according to the system distributor's instructions. The chips were read in the Zepto-Reader (PWG system, CCD camera-based) with different illumination times. The intensities determined as a function of the different sample concentrations are shown in FIG. 1.

### LITERATURE

¹ Beste, G.; Schmidt, F. S.; Stibora, T.; Skerra A.; Proc. Natl. Acad. Sci. USA (1999) 96, 1898-1903.
² Tiefenthaler et al.; U.S. Pat. No. 4,815,843 (1989).
³ Kunz, R.; U.S. Pat. No. 5,442,169 (1995).
⁴ Duveneck, G. L.; Neuschäfer, D.; Ehrat, M.; U.S. Pat. No. 5,959,292 (1999).
⁵ Duveneck, D. L.; Heming, M.; Neuschäfer, D.; Segner, J.; EP 0 759 159 (1995).
⁶ Neuschäfer, D.; Duveneck, G. L.; Pawlak, M.; Pieles, U.; Budach, W.; WO 96/35940 (1996).
⁷ Clerc, D. and Lukosz, W.; Sensors and Actuators B (1997) 40, 53-58.
⁸ Barner, R.; Fattinger, C.; Huber, W.; Hübscher, J.; Schlatter, D.; European patent application EP 0 596 421.
⁹ Budach, W.; Abel, A. P.; Bruno, A. E.; Neuschäfer, D.; Anal. Chem. (1999) 71, 3347-3355.
¹⁰ Piehler, J.; Brecht, A.; Geckeler, K. E.; Gauglitz, G.; Biosensors & Bioelectronics (1996) 11, 579-590.
¹¹ Schneider, B. H.; Dickinson, E. L.; Vach, M. D.; Hoijer, J. V.; Howard, L. V.; Biosensors & Bioelectronics (2000) 15, 13-22.
¹² Piehler, J.; Brecht, A.; Geckeler, K. E.; Gauglitz, G.; Biosensors & Bioelectronics (1996) 11, 579-590.
¹³ Porath, J. Protein Expr. Purif. (1992) 3, 263-281.
¹⁴ Buckland, R. M.; Nature (1986) 320, 557.

1. A polyelectrolyte mono- or multilayer for optical signal transducers, characterized in that the polyelectrolyte polymers have a particularly high molecular weight.

2. The polyelectrolyte mono- or multilayer for optical signal transducers according to claim 1, characterized in that the polyelectrolyte polymers a molecular weight of at least 100 000 g/mol.

3. The polyelectrolyte mono- or multilayer for optical signal transducers according to claim 1, characterized in that the polyelectrolyte polymers have a molecular weight of at least 250 000 g/mol.

4. The polyelectrolyte mono- or multilayer for optical signal transducers according to claim 1, characterized in that the polyelectrolyte polymers have a molecular weight of at least 500 000 g/mol.

5. The polyelectrolyte mono- or multilayer for optical signal transducers according to claims 1 to 4, characterized in that the polyelectrolyte polymers are anionic or cationic polymers.

6. The polyelectrolyte mono- or multilayer for optical signal transducers according to claims 1 to 4, characterized in that the polyelectrolyte polymers are selected from the group of: polyvinylamine, polyethyleneimine and poly(diallyldimethylammonium chloride).
